(19) United States
(12) Patent Application Publication
(10) Pub. No.: US 2010/0232059 A1
(43) Pub. Date: Sep. 16, 2010

(54) HARD DISK DRIVE

(75) Inventor: Dong Youl CHOI, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/722,827

(22) Filed: Mar. 12, 2010

(30) Foreign Application Priority Data
Mar. 12, 2009 (KR) 2009-0021275

(51) Int. Cl. G11B 33/14

(52) U.S. Cl. 360/97.02; G9B/33.036

(57) ABSTRACT

A hard disk drive includes a base provided with a plurality of interior component parts related to reading and writing information; a cover placed on a top surface of the base with the interior component parts therebetween and assembled to the base by a plurality of screws; a gasket interposed between the cover and the base to provide a seal between the cover and the base; and a reinforcing coupling part provided in the cover and the base to reinforce pressurization of the cover to the gasket when the cover is assembled to the base.

### CROSS-REFERENCE TO RELATED APPLICATIONS

This application claims the benefit under 35 U.S.C. §119(a) of Korean Patent Application No. 10-2009-0021275, filed on Mar. 12, 2009, in the Korean Intellectual Property Office, the disclosure of which is incorporated herein by reference in its entirety.

### BACKGROUND

1. Field of the Invention

The present general inventive concept relates to a hard disk drive, and more particularly, a hard disk drive which can reinforce pressurization of a cover to a gasket when the cover is coupled to a base even though it has a simple and uncomplicated structure, and thus maintain substantially uniform distribution of force applied to an assembling surface between the cover and the base, thereby preventing air leakage through a vulnerable part due to non-uniform distribution of the force.

2. Description of the Related Art

A hard disk drive that has been widely used as an auxiliary memory unit of a computer system or the like includes a base internally provided with interior component parts related to reading/writing information, and a cover covering a top surface of the base.

Such a hard disk drive is released as a product after forming an airtight interior structure to prevent introduction of external air.

Therefore, when assembling the conventional hard disk drive, the cover is put on a gasket after the gasket is attached to the top surface of the base to keep the hard disk drive airtight, and then six or seven screws are inserted in and fastened to the top surface of the base via the cover and the gasket at intervals along the circumference of the cover.

At this time, the gasket has to be further compressed as the screws are fastened with the gasket between the cover and the base, thereby making it advantageous to completely seal up an interior structure of the hard disk drive.

In such a conventional hard disk drive, the cover and the base are assembled depending on just several screws, so that an area where the screw is fastened and an area where the screw is not fastened can be different in a compressed degree of the gasket or the like, thereby causing a vulnerable part due to non-uniform distribution of force applied to the assembling surface between the cover and the base. In particular, a sealing effect between the cover and the base is reduced in the vulnerable part such as the area where the compressed degree of the gasket is low, etc., and thus air leakage is likely to occur in the vulnerable part.

But this does not mean that the sealing effect between the cover and the base can be enhanced by just increasing the number of screws. If the number of screws is just increased in assembling the cover and the base, there may arise various process losses such as a problem of increasing production cost due to an increased number of component parts, a problem of delaying an assembling time, a problem of increasing work effort, and so on.

Accordingly, there is needed a means that can reinforce pressurization of the cover to the gasket when the cover is coupled to the base even though it has a simple and uncomplicated structure, and thus maintain substantially uniform distribution of force applied to the assembling surface between the cover and the base, thereby preventing air leakage through a vulnerable part due to non-uniform distribution of the force.

### SUMMARY

Example embodiments of the present general inventive concept provides a hard disk drive which can reinforce pressurization of a cover to a gasket when the cover is coupled to a base even though it has a simple and uncomplicated structure, and thus maintain substantially uniform distribution of force applied to an assembling surface between the cover and the base, thereby preventing air leakage through a vulnerable part due to non-uniform distribution of the force.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a hard disk drive including a base provided with a plurality of interior component parts related to reading and writing information, a cover placed on a top surface of the base with the interior component parts therebetween and assembled to the base by a plurality of screws, a gasket interposed between the cover and the base to provide a seal between the cover and the base, and a reinforcing coupling part provided in the cover and the base to reinforce pressurization of the cover to the gasket when the cover is assembled to the base.

The reinforcing coupling part may include a protrusion formed in one of the cover and the base; and a groove formed in the other one of the cover and the base and to receive the protrusion.

The protrusion may be formed in a skirt bent from a circumferential surface of the cover toward the base, and the groove may be formed in a lateral side of the base.

The skirt may be provided continuously along a circumference of the cover to cover at least a portion of the lateral side of the base at an outer side.

The protrusion and the groove may be provided continuously along an inner surface of the skirt and a lateral circumference of the base, respectively.

The skirt may be formed integrally with the cover by a bending process.

A distance from a bottom surface of the cover to the protrusion may be smaller than a sum of a thickness of the gasket and a distance from the top surface of the base to the groove.

The protrusion and the groove may have corresponding shapes.

The protrusion and the groove may have a cross-section of a substantially right triangle hook shape.

The reinforcing coupling part may be used in a first assembly operation of the cover and the base, and the plurality of screws are used in a second assembly operation of the cover and the base in which the screws are inserted in holes of the cover and holes of the gasket and fastened to screw grooves of the base, and the reinforcing coupling part may cause the cover to apply substantially uniform pressurization on a whole surface of the gasket to prevent air leakage.

The protrusion may be arranged at a position distant from an exposed end part of the skirt.

The cover may include a recess where a head of the screw is placed.

The foregoing and/or other features and utilities of the present general inventive concept may also be achieved by providing a hard disk drive including a base provided with data reading and writing components, and a cover to cover the reading and writing components and having protrusions at a plurality of lateral portions thereof to couple the cover to the base.

The hard disk drive may include a plurality of fixing parts provided at top portions of the cover to fix the cover to the base.

The fixing parts may be screws.

The base may include grooves corresponding to the protrusions to receive the protrusions.

The grooves provided in the base may be continuous along lateral portions of the base.

The protrusions may be continuously provided along the lateral portions of the cover.

The protrusions may extend inwardly toward the base to occupy at least a portion of a corresponding space provided in lateral portions of the base.

The protrusions may extend outwardly to form a receiving portion at an inner surface of the lateral portions of the cover to receive an outwardly extending portion of the base.

The hard disk drive may further include a gasket provided between portions of the base and cover.

The gasket may be provided continuously at an outer area of a top of the base to provide a seal between contacted areas of the cover.

The protrusions may protrude from a skirt extending downwardly from the cover.

The skirt may be formed continuously with the cover.

The skirt may be affixed to a main body of the cover.

The skirt may contact lateral portions of the base to increase coupling stability between the cover and base.

The skirt may extend past the protrusions along the lateral portions of the base.

The respective protrusions may be extended into a first hole in the base through a corresponding second hole in the lateral portions of the cover.

The foregoing and/or other features and utilities of the present general inventive concept may also be achieved by providing a method of assembling a hard disk drive, the method including placing a cover over a base containing data reading and writing components such that protrusions at lateral portions of the cover couple the cover to the base, and fixing the cover to the base with a plurality of fixing parts.

The method may further include providing a gasket between the cover and base to seal an inner area of the base.

### BRIEF DESCRIPTION OF THE DRAWINGS

These and/or other features and advantages of the present general inventive concept will become apparent and more readily appreciated from the following description of the embodiments, taken in conjunction with the accompanying drawings of which:

FIG. 1 is an exploded perspective view illustrating a hard disk drive according to an exemplary embodiment of the present general inventive concept;

FIG. 2 is a partially sectional view illustrating an assembled state of the hard disk drive of FIG. 1;

FIG. 3 is a schematic exploded view illustrating the “A” part in FIG. 2;

FIG. 4 is an assembled view illustrating the “A” part in FIG. 2;

FIG. 5 is a sectional view illustrating a portion of a hard disk drive according to another exemplary embodiment of the present general inventive concept;

FIG. 6 is a sectional view illustrating a portion of a hard disk drive according to still another exemplary embodiment of the present general inventive concept;

FIG. 7 is a sectional view illustrating a portion of a hard disk drive according to yet another exemplary embodiment of the present general inventive concept;

FIG. 8 is a sectional view illustrating a portion of a hard disk drive according to yet another exemplary embodiment of the present general inventive concept;

FIG. 9 is a sectional view illustrating a portion of a hard disk drive according to yet another exemplary embodiment of the present general inventive concept;

FIG. 10 is a sectional view illustrating a portion of a hard disk drive according to yet another exemplary embodiment of the present general inventive concept;

FIG. 11 is a flow chart illustrating a method of assembling a hard disk drive according to an exemplary embodiment of the present general inventive concept.

### DETAILED DESCRIPTION OF THE EMBODIMENTS

Reference will now be made in detail to various exemplary embodiments of the present general inventive concept, examples of which are illustrated in the accompanying drawings, wherein like reference numerals refer to like elements throughout. The embodiments are described below in order to explain the present general inventive concept by referring to the figures.

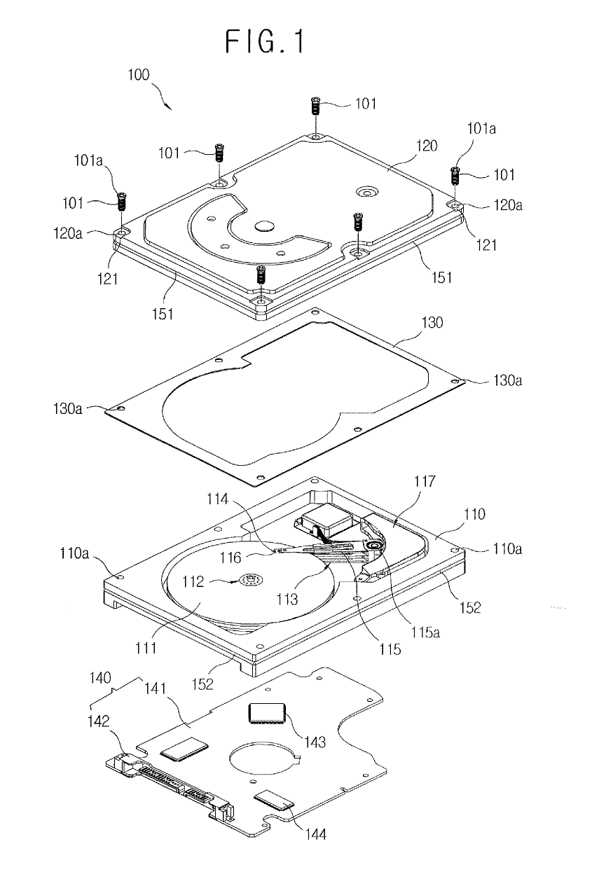

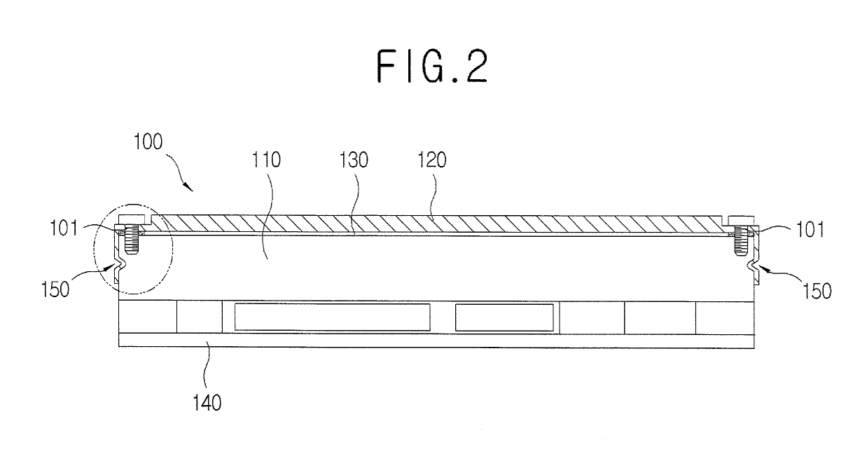

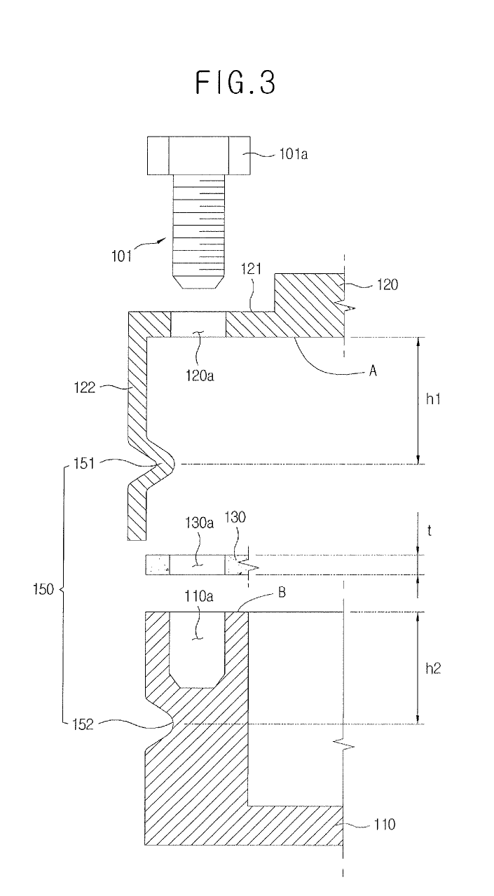

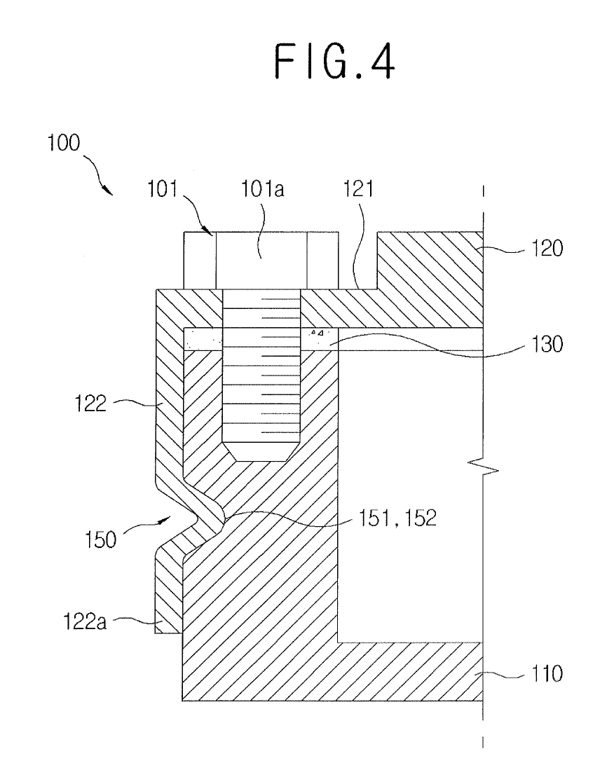

FIG. 1 is an exploded perspective view illustrating a hard disk drive according to an exemplary embodiment of the present general inventive concept, FIG. 2 is a partially sectional view illustrating an assembled state of the hard disk drive of FIG. 1, FIG. 3 is a schematic exploded view illustrating the “A” part in FIG. 2, and FIG. 4 is an assembled view illustrating the “A” part in FIG. 2.

As illustrated therein, a hard disk drive 100 according to this exemplary embodiment of the present general inventive concept may include a base 110 that may be internally provided with a plurality of interior component parts related to reading and writing information, a cover 120 provided to a top surface of the base 110 and assembled to the base 110 with the interior component parts therebetween, a gasket 130 interposed between the cover 120 and the base 110 to seal the inner area between the cover 120 and the base 110, and a printed circuit board assembly 140 coupled to the base 110.

Although the “top surface” of the base may be referred to at different times in this description, it is understood that such a directional term is merely relative to the orientation of the hard disk drive 100 illustrated in FIG. 1 and is employed simply to provide an easy frame of reference to understand relative positions of the base 110 and cover 120. It is also understood that if the hard disk drive 100 were to be inverted, the previously described “top surface” of the base 110 could be understood as the “bottom surface”, and so on, but may still receive the assembled cover 120 as described in this and various other embodiments of the present general inventive concept.

Referring to FIG. 1, the base 110 may be provided with the plurality of interior component parts related to reading and writing information. For example, the base 110 may be provided with at least one disk 111 to record and/or store data, a spindle motor 112 provided in the center of the disk 111 to rotate the disk 111, a head stack assembly (HAS) 113 to move a magnetic head 114 to various areas adjacent to the disk 111, etc.

The base 110 may be classified as a flat type in which the interior component parts are provided and/or assembled to a flat top surface thereof, a bowl type in which the interior component parts are accommodated and assembled therein, or various other configurations.

In this embodiment, the bowl-type base 110 will be described, but it is understood that the present general inventive concept is not limited thereto. For example, the present inventive concept may alternatively be applied to the flat-type base (not shown), or to other various configurations of bases.

The hard disk drive 100 in this embodiment of the present general inventive concept may be a small form factor hard disk drive (SFF HDD) in which the disk 111 having a diameter of 1.8 inch is applied, but the present general inventive concept is not limited thereto. For example, the present inventive concept may alternatively be applied to all hard disk drives regardless of large, small and medium forms.

As one of the interior component parts, the HSA 113 may include the magnetic head 114 to record and load data on the disk 111, and an actuator 115 to fly the magnetic head 114 so that the magnetic head 114 can access the data on the disk 111 or store data thereon.

The magnetic head 114 may be provided at a front end of a head gimbal 116 extended from and connected to the actuator 115, and may fly while keeping a minute gap between the magnetic head 114 and the surface of the disk 111 by rising up due to an air current on the surface of the disk 111 generated as a plurality of disks 111 rotates at high speed.

The actuator 115 may be provided with respect to a pivot shaft 115a and may be rotatable so as to move the magnetic head 114 to different areas adjacent to the disk 111. That is, the actuator 115 may move left and right by operations of a voice coil motor (VCM) 117 provided at one end thereof, so that the magnetic head 114 provided at the other end can record or read data in or from a track on the disk 111 while moving in a substantially radial direction over the disk 111.

Although not illustrated in the drawings, a latch (not shown) may be placed under the voice coil motor 117 so as to elastically support the actuator 115 and prevent the actuator 115 from voluntarily moving when the magnetic head 114 is parked at a parking zone (not shown) of the disk 111. Alternatively, a support such as a separate ramp may be provided so that the magnetic head 114 may be parked in the ramp. In the embodiment illustrated in FIG. 1, such a parking area is not provided to the disk 111.

Prior to a description of the cover 120, the PCBA 140 will be described. The PCBA 140 may be coupled to a bottom surface of the base 110.

The PCBA 140 may include a printed circuit board (PCB) 141 provided with a plurality of circuit elements, and a connector 142 connected to one side of the PCB 141.

The PCB 141 may be provided with a controller 143 to control various functions of the hard disk drive 100. Further, a plurality of memories 144 may be provided to the PCB 141 so as to store various data, tables or the like.

Meanwhile, the cover 120 may cover the top surface of the base 110 and protect the plurality of interior component parts.

The cover 120 may be made of metal. For example, the cover 120 may be made by die-casting aluminum alloy, pressing steel, or other similar processes/materials, or a combination of more than one of these.

The cover 120 may be assembled to the base 110 by a plurality of screws 101, e.g., by six screws 101 in this embodiment. Also, the cover 120 may be formed with one or more recesses 121 where a respective head 101a of the screw 101 is placed.

While the presently described embodiment of the present general inventive concept is described as using the screws 101 to assemble the cover 120 to the base 110, it is understood that any number of alternate fixing and/or adhesion devices may be used instead of, or in conjunction with, the screws 101.

The gasket 130 may be provided to form a seal between the cover 120 and the base 110 when the cover 120 and the base 110 are assembled by the screws 101. The gasket 130 may be made of rubber, and may form a continuous closed loop along a circumference on the top surface of the base 110 as long as it does not interfere with the interior component parts.

Thus, the gasket 130 and the cover 120 may be sequentially provided to the top surface of the base 110, and then the screws 101 may be inserted in holes 120a of the cover 120 and holes 130a of the gasket 130 and fastened to the screw grooves 110a of the base 110, thereby being assembled into the hard disk drive 100.

However, if the hard disk drive 100 is assembled by such a general method, as described above an area in which the screw 101 is fastened and an area in which the screw 101 is not fastened are different in a compressed degree of the gasket 130 or the like, thereby causing a vulnerable part due to non-uniform distribution of force applied to the assembling surface between the cover 120 and the base 110. In particular, a sealing effect between the cover 120 and the base 110 is reduced in the vulnerable part such as the area where the compressed degree of the gasket 130 is low, etc., and thus air leakage is likely to occur in the vulnerable part.

Of course, the problem of the air leakage may be caused by processing tolerance and assembling tolerance of the component parts, but if the processing tolerance and the assembling tolerance of the component parts are acceptable within a tolerance limit, the problem of the air leakage may be caused depending on the compressed degree of the gasket 130 interposed between the cover 120 and the base 110, in the vulnerable part such as the area in which the compressed degree 130 of the gasket 130 is low, etc.

To solve at least this problem, there may be provided a reinforcing coupling part 150 in this embodiment of the present general inventive concept.

The reinforcing coupling part 150 may be provided to the cover 120 and the base 110, and may maintain substantially uniform distribution of force applied on to the assembling surface between the cover 120 and the base 110 upon assembly of the cover 120 and the base 110.

In this embodiment of the present general inventive concept, as illustrated in FIGS. 3 and 4, the reinforcing coupling part 150 may include a protrusion 151 formed on the cover 120, and a groove 152 formed in the base 110 to accommodate the protrusion 151 of the cover 120 when the cover 120 and the base 110 are assembled.

In this embodiment of the present general inventive concept, the protrusion 151 may be formed on a skirt 122 extending from a circumferential surface of the cover 120 toward the base 110, and the groove 152 may be formed in a lateral side of the base 110.

In general, because the cover 120 may be flat, it may thus be difficult to form the protrusion 151 on the cover 120. To form the protrusion 151 illustrated in FIGS. 3-4, the cover 120 in this embodiment is provided with the skirt 122, and the protrusion 151 is formed on the skirt 122.

The skirt 122 may be continuously provided along the circumference of the cover 120 to cover the lateral sides of the base 110 at outer sides (refer to FIG. 1). In this example embodiment, the protrusion 151 may be provided at a position offset from an exposed end part 122a (refer to FIG. 4) of the skirt 122. As the protrusion 151 may be provided at the offset position from the exposed end part 122a of the skirt 122, the exposed end part 122a of the skirt 122 may press the lateral side of the base 110 throughout a large area, thereby enhancing the coupling force between the cover 120 and the base 110 and thus preventing easy separation of the protrusion 151 from the groove 152. However, the present general inventive concept is not limited thereto.

As described above, the cover 120 may be made by die-casting aluminum alloy, by pressing steel, or other modes of fabrication. In the case in which the die-casting of aluminum alloy is used, the skirt 122 and the protrusion 151 may be simultaneously manufactured at a die-casting process of the cover 120. In the case in which steel is pressed to form the cover 120, after manufacturing the cover 120, the skirt 122 may be formed by bending the cover 120 and the protrusion 151 may be formed on the skirt 122 by pressing the skirt 122.

For reference, the aforementioned die-casting may be a precise casting method that pours liquid metal into a steel mold mechanically processed to be matched with a needed molding shape to obtain the same shape as the inside of the mold.

Similarly, the groove 152 may be formed integrally with the lateral side of the base 110 when forming the base 110, or may be formed by electric discharging machining after forming the base 110, or by other fabrication methods. The electric discharging machining is a method which may obtain a desired shape by using physical, mechanical and electrical actions generated when electric discharge occurs between two electrodes.

Meanwhile, it may be preferable, though not necessary, that the protrusion 151 and the groove 152 are continuously provided along the inner surface of the skirt 122 and the lateral circumference of the base 110, respectively. Thus, the distribution of the force applied to the assembling surface between the cover 120 and the base 110 can be kept substantially uniform upon assembly of the cover 120 and the base 110, thereby solving at least the problem of the air leakage.

However, the present general inventive concept is not limited thereto. Alternatively, the protrusion 151 and the groove 152 may be discontinuously provided in at least a partial section along the inner surface of the skirt 122 and the lateral circumference of the base 110, respectively. In this case, it is advantageous that the protrusion 151 and the groove 152 are formed in a section between the screws 111.

Further, to maintain the substantially uniform distribution of the force applied onto the assembling surface between the cover 120 and the base 110, the protrusion 151 and the groove 152 has not to be freely separated from each other. Thus, it is preferable that the groove 151 and the groove 152 have corresponding shapes to match with each other. In this embodiment, it is proposed that the protrusion 151 and the groove 152 are shaped to have a rounded triangular cross-section.

In forming the protrusion 151 and the groove 152 on the inner surface of the skirt 122 and the lateral circumference of the base 110, respectively, it is preferable that a distance h1 from the bottom surface A of the cover 120 to the protrusion 151 is smaller than the sum (t+h2) of a thickness t of the gasket 130 and a distance h2 from the top surface B of the base 110 to the groove 152. Under this condition, when the protrusion 151 is fitted in the groove 152 and thus the cover 120 and the base 110 are firstly assembled, the distribution of the force applied onto the assembling surface between the cover 120 and the base 110 can be substantially uniformly maintained while generally a little compressing the gasket 130. However, the present inventive concept is not limited to this matter.

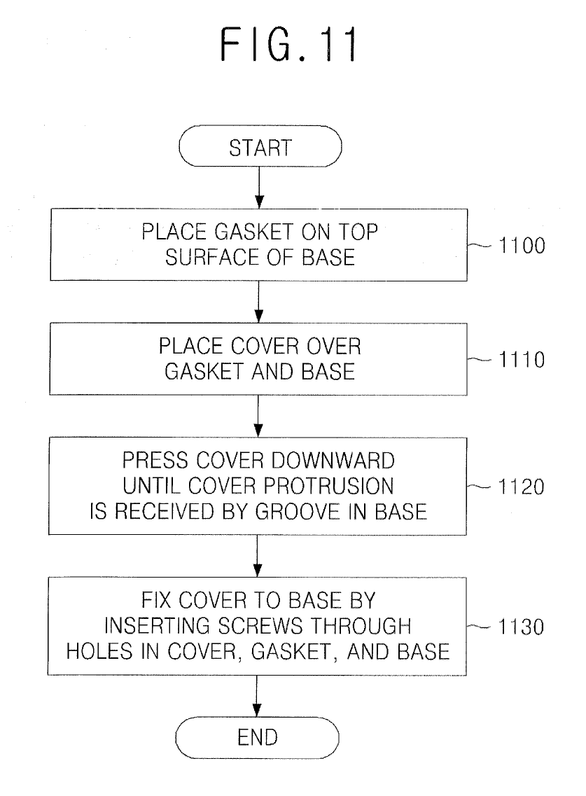

With this configuration, a schematic method of assembling the hard disk drive 100 is as follows. This assembly method is illustrated in the flow chart of FIG. 11.

First, in operations 1100 and 1110, the gasket 130 and the cover 120 are arranged in sequence on the top surface of the base 120 as shown in FIG. 3.

Then, in operation 1120, the protrusion 151 formed on the skirt 122 of the cover 120 is matched with and fitted in the groove 152 formed on the base 120, thereby firstly assembling the cover 120 and the base 110. In other words, the cover 120 may be pressed downward toward the base 110 until the protrusion 151 is received by the groove 152 of the base 110.

At this time, as described above, the cover 120 and the base 110 are firstly assembled while generally slightly compressing the gasket 130, thereby assisting the distribution of the force applied onto the assembling surface between the cover 120 and the base 110 to be substantially uniformly maintained.

Next, in operation 1130, six screws 101 are prepared and inserted in the holes 120a of the cover 120 and the holes 130a of the gasket 130, and fastened to the screw groove 110a of the base 110, thereby completing the assembly of the hard disk drive 110 as shown in FIG. 4.

As the hard disk drive 100 is completely assembled by the foregoing method, the first assembled protrusion 151 maintains the substantially uniform distribution of the force applied onto the assembling surface between the cover 120 and the base 110 in the area of the groove 152, and then the screw 101 finally completes the assembly, thereby preventing the air leakage from occur through the vulnerable part due to non-uniform distribution of the force.

Thus, with a simple and not-complicated structure according to an exemplary embodiment of the present inventive concept, the gasket 130 is compressed when the cover 120 is coupled to the base 110, thereby sealing up the cover 120 and the base 110. In other words, the reinforcing coupling part 150 makes the cover 120 apply substantially uniform pressurization to the whole surface of the gasket 130, and thus maintains the substantially uniform distribution of the force applied to the assembling surface between the cover 120 and the base 110, thereby preventing the air leakage from occur through the vulnerable part due to non-uniform distribution of the force.

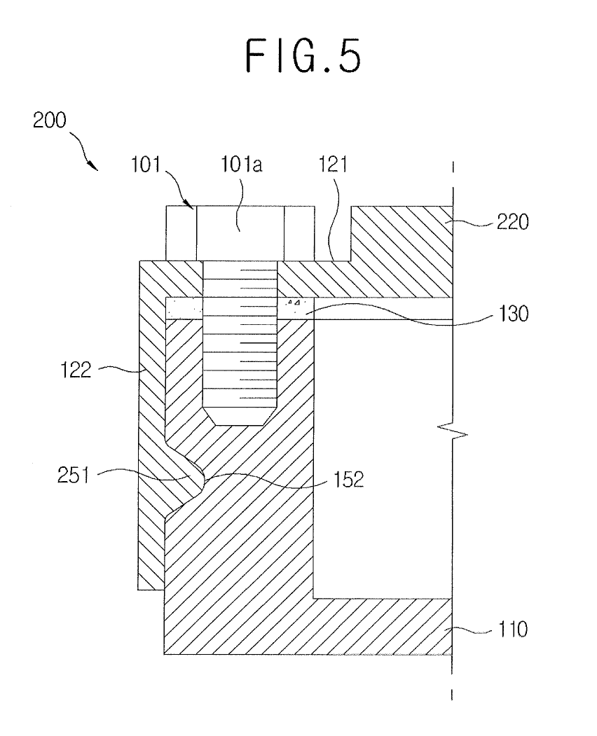

FIG. 5 is a sectional view of a major part of a hard disk drive according to a second exemplary embodiment of the present inventive concept.

As shown therein, a hard disk drive 200 in this embodiment has a different-shaped protrusion 251 formed on the skirt 122 of the cover 120. That is, the skirt 122 shown in FIGS. 3 and 4 is pressed and bent at one side to form the protrusion 151, but the skirt 122 shown in FIG. 5 has an even outer surface and a protruded inner surface. The protrusion 251 can be formed integrally with the cover 220 by the die-casting process when manufacturing the cover 220.

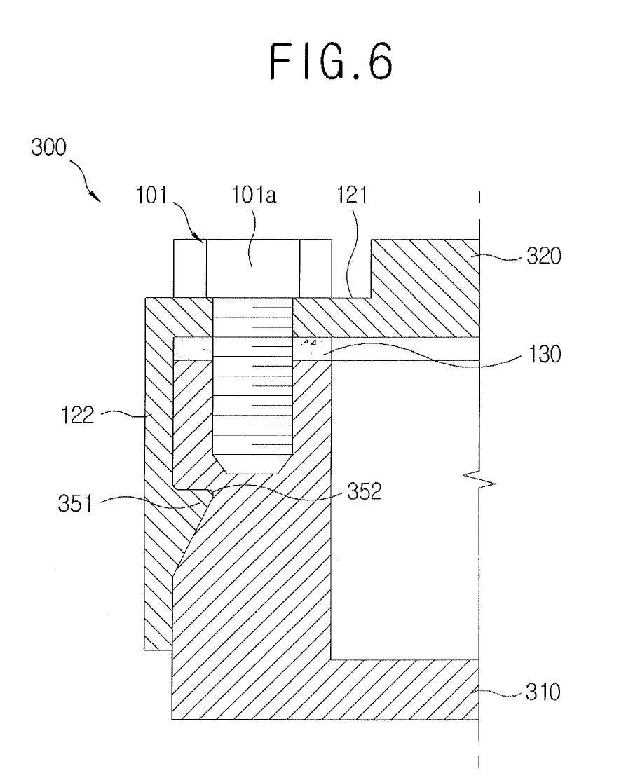

FIG. 6 is a sectional view of a major part of a hard disk drive according to a third exemplary embodiment of the present inventive concept.

As shown therein, a hard disk drive 300 in this embodiment includes a protrusion 351 and a groove 352 respectively formed in a cover 320 and a base 310 and having a cross-section of a right triangle hook shape.

If the protrusion 351 and the groove 352 are manufactured to have the shapes shown in FIG. 6, there is a merit that the protrusion 351 is not easily separated from and more strongly fastened to the groove 352 as it is first assembled to the groove 352.

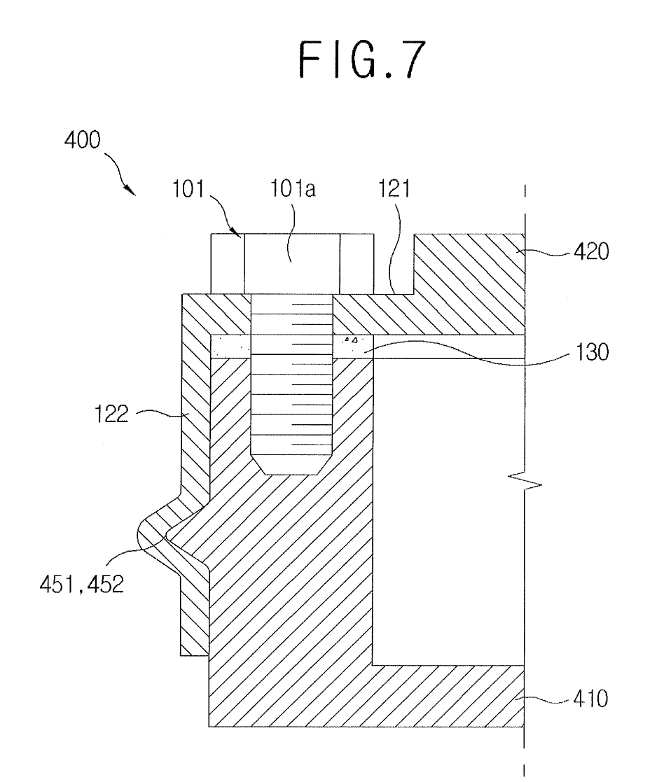

FIG. 7 is a sectional view of a major part of a hard disk drive according to a fourth exemplary embodiment of the present inventive concept.

As shown therein, a hard disk drive 400 in this embodiment includes a protrusion 451 and a groove 452 different in positions from those of the foregoing embodiments. That is, the protrusion 451 and the groove 452 shown in FIG. 7 are formed on a base 410 and a cover 420, respectively, but there is no change in the effect of the present inventive concept.

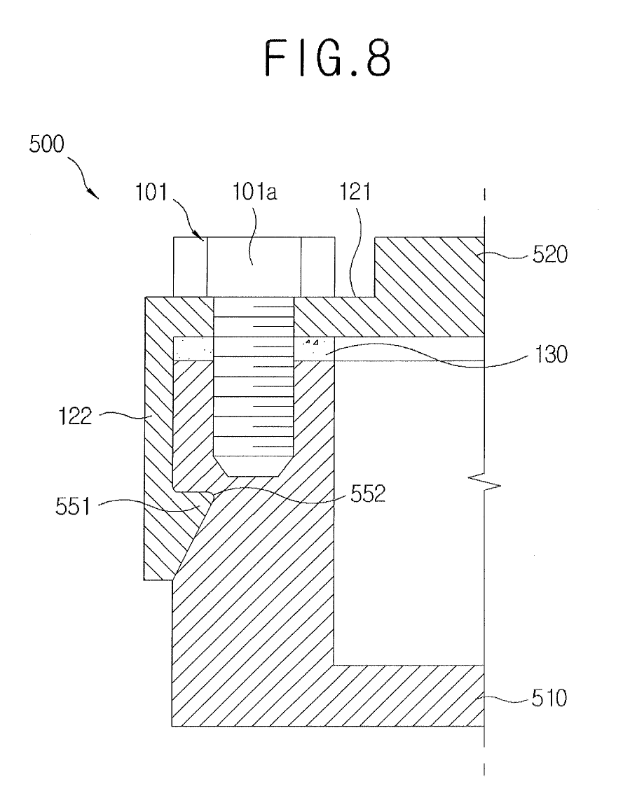

FIG. 8 is a sectional view of a major part of a hard disk drive according to a fifth exemplary embodiment of the present inventive concept.

As shown therein, a hard disk drive 500 in this embodiment includes a protrusion 551 formed in an exposed end part of a skirt 122 bent and extended from the cover 520, and a groove 552 formed in a base 510 at a position corresponding to the protrusion 551. That is, the protrusion 551 is provided at the last end part of the skirt 122 while providing the same effect of the present inventive concept.

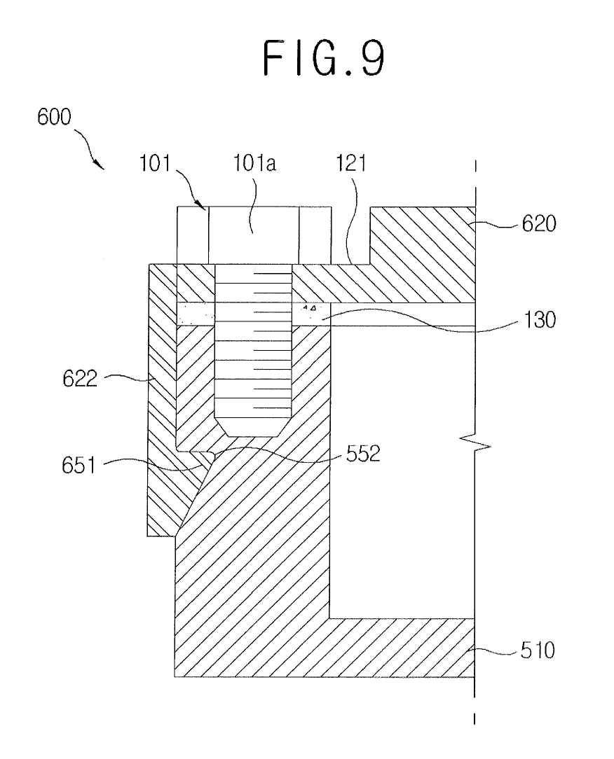

FIG. 9 is a sectional view of a major part of a hard disk drive according to a sixth exemplary embodiment of the present inventive concept.

As shown therein, a hard disk drive 600 in this embodiment includes a cover 620 and a skirt 622 which are separately manufactured and then coupled to each other as shown in FIG. 9. Here, the cover 620 and the skirt 622 may be coupled by welding, screws or the like method. In this case, it may be advantageous that a protrusion 651 and the skirt 622 are formed as a single body.

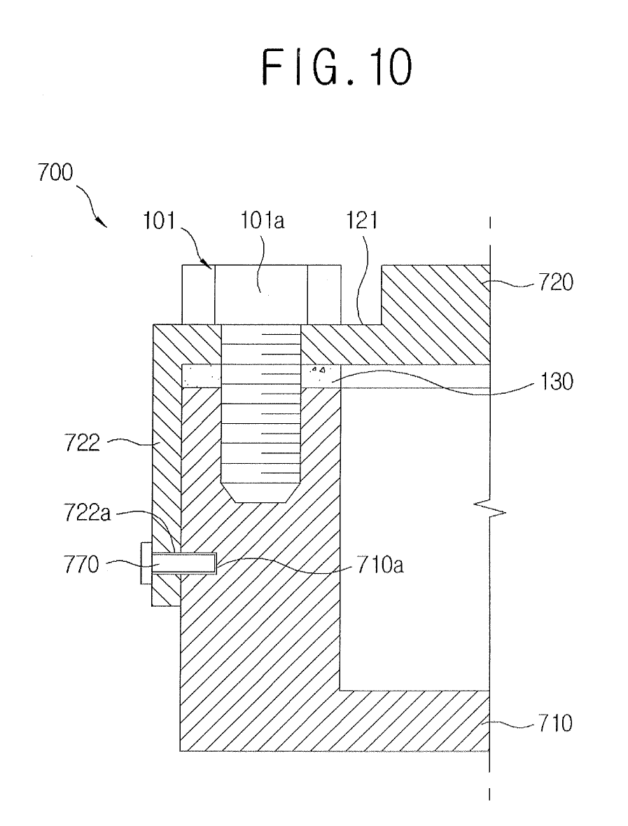

FIG. 10 is a sectional view of a major part of a hard disk drive according to a seventh exemplary embodiment of the present inventive concept.

As shown therein, a hard disk drive 700 in this embodiment includes a pin hole 722a formed in a skirt 722 of the cover 720, a pin hole 710a formed at a lateral side of a base 710, a pin 770 inserted in the pin holes 722a and 710a aligned with each other. Although the structure shown in FIG. 10 is applied, the gasket 130 can be compressed to seal up an assembling surface between the cover 720 and the base 710 when the cover 720 is assembled to the base 710. Thus, the distribution of force applied to the assembling surface between the cover 720 and the base 710 can be maintained substantially uniform, thereby preventing air leakage through a vulnerable part due to non-uniform distribution of the force.

As described above, there is provided a hard disk drive which can reinforce pressurization of a cover to a gasket when the cover is coupled to a base even though it has a simple and not-complicated structure, and thus maintain substantially uniform distribution of force applied to an assembling surface between the cover and the base, thereby preventing air leakage through a vulnerable part due to non-uniform distribution of the force.

Although various exemplary embodiments of the present general inventive concept have been illustrated and described, it will be appreciated by those skilled in the art that changes may be made in these example embodiments without departing from the principles and spirit of the general inventive concept, the scope of which is defined in the appended claims and their equivalents.

What is claimed is:

1. A hard disk drive comprising:
a base provided with a plurality of interior component parts related to reading and writing information;
a cover placed on a top surface of the base with the interior component parts therebetween and assembled to the base by a plurality of screws;
a gasket interposed between the cover and the base and to provide a seal between the cover and the base; and
a reinforcing coupling part provided in the cover and the base to reinforce pressurization of the cover to the gasket when the cover is assembled to the base.

2. The hard disk drive according to claim 1, wherein the reinforcing coupling part comprises:
a protrusion formed in one of the cover and the base; and
a groove formed in the other one of the cover and the base and to receive the protrusion.

3. The hard disk drive according to claim 2, wherein the protrusion is formed in a skirt bent from a circumferential surface of the cover toward the base; and
the groove is formed in a lateral side of the base.

4. The hard disk drive according to claim 3, wherein the skirt is provided continuously along a circumference of the cover to cover at least a portion of the lateral side of the base at an outer side.

5. The hard disk drive according to claim 4, wherein the protrusion and the groove are provided continuously along an inner surface of the skirt and a lateral circumference of the base, respectively.

6. The hard disk drive according to claim 3, wherein the skirt is formed integrally with the cover by a bending process.

7. The hard disk drive according to claim 2, wherein a distance from a bottom surface of the cover to the protrusion is smaller than a sum of a thickness of the gasket and a distance from the top surface of the base to the groove.

8. The hard disk drive according to claim 2, wherein the protrusion and the groove have corresponding shapes.

9. The hard disk drive according to claim 2, wherein the protrusion and the groove have a cross-section of a substantially right triangle hook shape.

10. The hard disk drive according to claim 1, wherein the reinforcing coupling part is used in a first assembly operation of the cover and the base, and the plurality of screws are used in a second assembly operation of the cover and the base in which the screws are inserted in holes of the cover and holes of the gasket and fastened to screw grooves of the base; and
the reinforcing coupling part causes the cover to apply substantially uniform pressurization on a whole surface of the gasket to prevent air leakage.

11. The hard disk drive according to claim 3, wherein the protrusion is arranged at a position distant from an exposed end part of the skirt.

12. The hard disk drive according to claim 1, wherein the cover comprises a recess where a head of the screw is placed.

13. A hard disk drive comprising:
a base provided with data reading and writing components; and
a cover to cover the reading and writing components and having protrusions at a plurality of lateral portions thereof to couple the cover to the base.

14. The hard disk drive according to claim 13, wherein the base comprises grooves corresponding to the protrusions to receive the protrusions.

15. The hard disk drive according to claim 13, wherein the protrusions extend outwardly to form a receiving portion at an inner surface of the lateral portions of the cover to receive an outwardly extending portion of the base.

16. The hard disk drive according to claim 13, further comprising a gasket provided between portions of the base and cover.

17. The hard disk drive according to claim 16, wherein the gasket is provided continuously at an outer area of a top of the base to provide a seal between contacted areas of the cover.

18. The hard disk drive according to claim 13, wherein the protrusions protrude from a skirt extending downwardly from the cover.

19. The hard disk drive according to claim 18, wherein the skirt is formed continuously with the cover.

20. A method of assembling a hard disk drive, the method comprising:
placing a cover over a base containing data reading and writing components such that protrusions at lateral portions of the cover couple the cover to the base; and
fixing the cover to the base with a plurality of fixing parts.
